(19) United States
(12) Patent Application Publication
(10) Pub. No.: US 2026/0252812 A1
(43) Pub. Date: Aug. 27, 2026

(54) LARGE LANGUAGE MODELS IN COMPETITION TO SELECT AN OPTIMAL RESPONSE TO A PROMPT

(71) Applicant: INTERNATIONAL BUSINESS MACHINES CORPORATION, ARMONK, NY (US)

(72) Inventors: Gennaro Anthony Cuomo, Raleigh, NC (US); Blaine H. Dolph, Western Springs, IL (US); Luis Fernando Munoz, Centennial, CO (US)

(21) Appl. No.: 19/061,533

(22) Filed: Feb. 24, 2025

(51) Int. Cl. G06F 40/40

(52) U.S. Cl. CPC G06F 40/40

(57) ABSTRACT

An approach is provided for optimal response selection. A prompt is received from a user and standardized and adjusted by pre-processing, tokenizing, and cleaning, so that the standardized and adjusted prompt is compatible with contestant large language models (LLMs). One or more evaluation criteria are determined for evaluating responses to the prompt. In parallel and simultaneously, the prompt and the one or more evaluation criteria are distributed to the contestant LLMs. The responses to the prompt are generated and evaluated by the LLMs based on the one or more evaluation criteria. Rankings of the responses are generated by the LLMs. A top-ranked response is determined by aggregating the rankings. A winning LLM is identified among the LLMs based on the winning LLM having generated the top-ranked response. The top-ranked response and an identification of the winning LLM are sent to the user.

### BACKGROUND

The present invention relates to artificial intelligence model benchmarking, and more particularly to a competitive process for evaluating large language models (LLMs).

### SUMMARY

In one embodiment, the present invention provides a computer-implemented method. The method includes receiving a prompt from a user and standardizing and adjusting the prompt by pre-processing, tokenizing, and cleaning the prompt, so that the standardized and adjusted prompt is compatible with contestant large language models (LLMs). The method further includes determining one or more evaluation criteria for evaluating responses to the prompt. The method further includes distributing, in parallel and simultaneously, the prompt and the one or more evaluation criteria to the contestant LLMs. The method further includes generating and evaluating the responses to the prompt. The method further includes, based on the one or more evaluation criteria, generating rankings of the responses. The responses and the rankings are generated by the contestant LLMs, respectively. The method further includes determining a top-ranked response included in the responses by aggregating the rankings. The method further includes identifying a winning LLM among the contestant LLMs based on the winning LLM having generated the top-ranked response. The method further includes sending the top-ranked response and an identification of the winning LLM to the user.

A computer system and a computer program product corresponding to the above-summarized computer-implemented method are also described herein.

### BRIEF DESCRIPTION OF THE DRAWINGS

FIG. 1 is a block diagram of a system for selecting an optimal response for LLM benchmarking, in accordance with embodiments of the present invention.

FIG. 2 is a block diagram of modules included in code included in the system of FIG. 1, in accordance with embodiments of the present invention.

FIG. 3 is a block diagram of a system for selecting an optimal response using a competition among multiple large language models (LLMs), in accordance with embodiments of the present invention.

FIG. 4 is a flowchart of a process of selecting an optimal response for LLM benchmarking, where operations of the flowchart are performed by modules in FIG. 2, which are implemented by the system of FIG. 3, in accordance with embodiments of the present invention.

FIG. 5 is an example of topic modeling used to implement privacy preservation in the process of FIG. 4, in accordance with embodiments of the present invention.

FIGS. 6A-6C depict an example of selecting an optimal response and a winning LLM by using the process of FIG. 4, in accordance with embodiments of the present invention.

FIGS. 7A-7C depict an example of code illustrating a conceptual framework and a core logic of a large language model evaluation engine included in the system of FIG. 3, in accordance with embodiments of the present invention.

### DETAILED DESCRIPTION

### OVERVIEW

Large language models (LLMs) have gained significant attention and popularity recently due to their ability to generate human-like responses to a wide range of prompts. The LLMs use sophisticated algorithms and massive amounts of training data to learnt the patterns and structures of natural language, allowing them to produce coherent and contextually appropriate responses. Significant advancements have occurred in natural language processing (NLP) in recent years, including the development of various large language models, such as GPT-3, BERT, and others. These models are capable of generating human-like text and understanding the nuances of language to a certain degree. Using known techniques, selecting the best response from multiple large language models for a given prompt remains a challenge. Traditional methods of selecting a best response involve either human evaluation or statistical techniques, both of which have limitations.

Human evaluation can introduce unwanted subjectivity and inconsistency in the results of selecting a best response because different human evaluators have different interpretations of what constitutes the best response. Human evaluators introduce human biases (e.g., cultural, personal, or cognitive biases) into the evaluation process, thereby unfairly favoring certain types of responses or certain large language models. Further, human evaluation is time-consuming, costly, and error-prone due to the evaluation task having a heavy cognitive load, making it impractical to evaluate responses at scale.

Statistical techniques for selecting the best response includes using BLEU score, perplexity, or ROUGE score. Techniques using BLEU score or ROUGE score includes analyzing the overlap of n-grams, which emphasizes word matching (i.e., matching between model output and reference responses), while failing to account for the semantics and relevance of responses. Statistical techniques using perplexity measures how well a model predicts the next word in a sequence, but fails to reward a response that is meaningful or relevant to the prompt. The aforementioned statistical techniques have an inability to assess the context of a response or whether the response answers the prompt in a coherent manner. Further, the aforementioned statistical techniques are insensitive to meaningful errors (e.g., overlook errors that significantly impact the quality of a response) and lack an alignment with a human judgment of what makes a response a best response (e.g., by failing to account for factors that humans care about, such as relevance, creativity, engagement, and clarity).

Embodiments of the present invention address the aforementioned unique challenges by providing an approach to benchmarking LLMs by designating large language models (LLMs) as “contestants” that compete against each other to generate the most favorable response to natural language prompts given evaluative criteria. The same LLMs that are participating in the competition are also the judging LLMs that evaluate the responses. A winning LLM is established through a comparative rating process. This process requires the analysis and scoring of the responses of all participating LLMs (also referred to herein as the contestant LLMs) against specified criteria. The responses, the scores and rankings of the responses, explanations for the scoring and ranking, the evaluative criteria, the natural language prompts, and the high-scoring (i.e., winning) LLMs are subsequently cataloged in a benchmarking database. The database serves as a performance log, facilitating model comparisons, progress tracking, strength and weakness identification, and continuous learning, thereby enhancing the efficiency of the ongoing response evaluation process. The LLM benchmarking approach disclosed herein integrates competition among substantial LLMs, leading to a dynamic, unbiased (with no human intervention), and context-sensitive evaluation process, while providing researchers and developers with insights to guide decisions, track progress, and stimulate breakthroughs in the realm of natural language processing (NLP).

In one embodiment, the optimal response selection for LLM benchmarking approach disclosed herein employs enhanced prompt engineering strategies in the realm of NLP and artificial intelligence (AI) to benchmark and improve the performance of LLMs.

In one embodiment, the optimal response selection for LLM benchmarking approach disclosed herein employs language modeling itself to evaluate language modeling. By presenting multiple LLMs with the same prompt and employing an approach that allows the LLMs to compete against each other, all of the responses generated by the LLMs are judged and ranked by each LLM based on one or more evaluation criteria. This competitive process creates a comprehensive and accurate dataset, allowing for a selection of the best LLM based (i.e., winning LLM) on the best LLM's performance against the given prompt (i.e., a selection of the LLM that generated the best response based on the one or more evaluation criteria).

In one embodiment, the optimal response selection for LLM benchmarking approach disclosed herein involves prompt evaluation, distributed processing, and response scoring. The LLMs compete, providing responses that are evaluated and scored based on specific criteria. As the benchmarking database is populated over time, the cost of benchmarking using the approach disclosed herein decreases because the full approach need not be run each time. The process not only provides continuous benchmarking of large language models, but also creates a more cost-effective system for response selection in prompt engineering.

In one embodiment, the optimal response selection for LLM benchmarking approach disclosed herein provides an efficient method for benchmarking large language models through a competitive evaluation process. This approach utilizes LLMs that are presented with a prompt and one or more criteria for evaluation, generating responses that are subsequently scored based on several parameters.

In one embodiment, the optimal response selection for LLM benchmarking approach disclosed herein transforms the art of language modeling into an evaluative tool, and is not merely a static comparison, but rather a dynamic, contextually-relevant competition among LLMs. The approach disclosed herein includes a unique interplay among the benchmarking database, model intercommunication, and adaptive prompt evaluation. The approach disclosed herein includes a novel use of LLMs as both contestants and judges in the evaluation process that evaluates and ranks responses to a prompt.

Advantages of the embodiments described herein are presented and described below:
Dynamic and Continuous Benchmarking: Unlike known static methods, the optimal response selection and LLM benchmarking approach disclosed herein provides ongoing benchmarking, accommodating for the continual advancements in LLMs. This dynamic nature ensures that evaluation is always in sync with the latest LLM improvements, providing more accurate and relevant results.
Self-Evaluation and Bias Elimination: The innovative approach disclosed herein employs the LLMs themselves to establish evaluation criteria and judge responses. This unique setup eliminates human bias and enhances the fairness and accuracy of the benchmarking process.
Contextually Relevant Results: With large language models judging their responses based on the prompt's context, the approach disclosed herein provides results that are more relevant and meaningful compared to traditional, static benchmarks, where the results provide a deeper insight into a model's capability to understand and respond to various prompts.
Cost-effective Benchmarking: As the benchmarking database populates over time, the need for running the full process for optimal response selection disclosed herein for every evaluation diminishes, thereby providing an efficiency that results in lower costs associated with the benchmarking process, and making the approach disclosed herein a cost-effective solution for the long-term.
Adaptive and Flexible Evaluation: The system for optimal response selection and LLM benchmarking disclosed herein adapts to the complexities of different prompts, with scoring criteria tailored to the specifics of each prompt, thereby allowing a flexibility that ensures a more accurate and comprehensive evaluation of LLM performance.

### COMPUTING ENVIRONMENT

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, computer-readable storage media (also called “mediums”) collectively included in a set of one, or more, storage devices, and that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

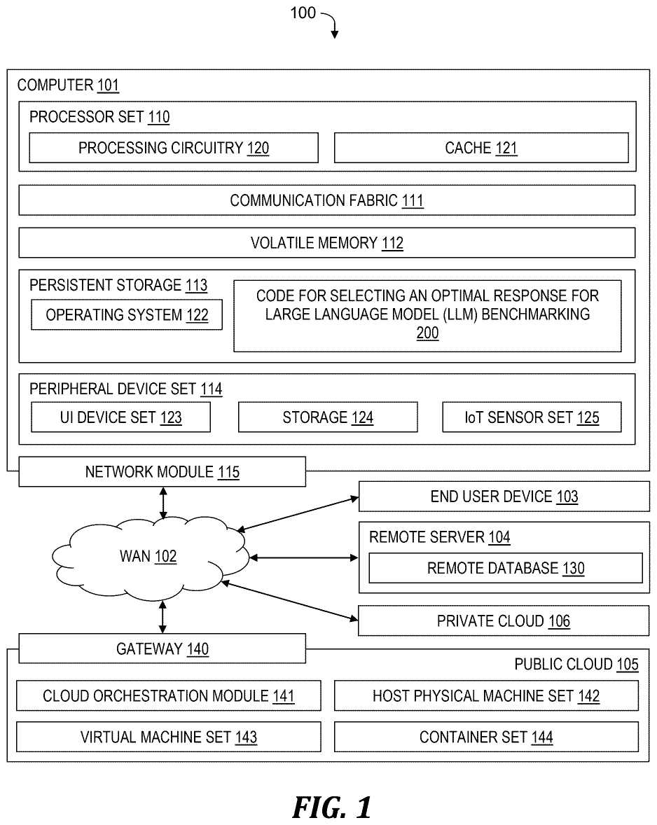

FIG. 1 is a block diagram of a system for selecting an optimal response for LLM benchmarking, in accordance with embodiments of the present invention. Computing environment 100 contains an example of an environment for the execution of at least some of the computer code involved in performing the inventive methods, such as code 200 for selecting an optimal response for LLM benchmarking. The aforementioned computer code is also referred to herein as computer-readable code, computer-readable program code, and machine readable code. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

### SYSTEM AND PROCESS FOR SELECTING AN OPTIMAL RESPONSE FOR LLM BENCHMARKING

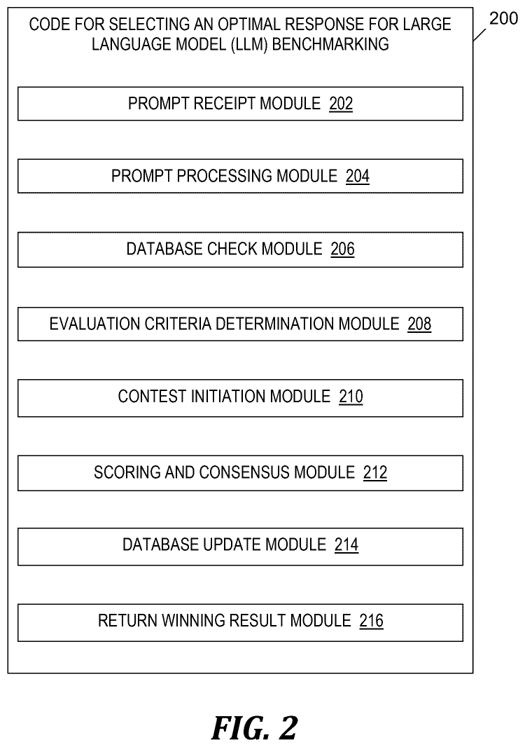

FIG. 2 is a block diagram of modules included in code 200 included in the system of FIG. 1, in accordance with embodiments of the present invention. Code 200 includes a prompt receipt module 202, a prompt processing module 204, a database check module 206, an evaluation criteria determination module 208, a contest initiation module 210, a scoring and consensus module 212, a database update module 214, and a return winning result module 216.

Prompt receipt module 202 is configured to receive a natural language prompt from a device or other computer system utilized by a user.

Prompt processing module 204 is configured to standardize and adjust the prompt received by prompt receipt module 202, where the standardizing and adjusting includes pre-processing, tokenizing, and cleaning the prompt. Prompt processing module 204 checks and verifies that the standardized and adjusted prompt is compatible with contestant LLMs.

Database check module 206 is configured to determine a prompt style of the prompt processed by prompt processing module 204, and query the benchmarking database to determine whether the prompt style already exists in the benchmarking database by using topic modeling techniques. If the querying of the benchmarking database determines that the prompt style already exists in the benchmarking database, then database check module 206 retrieves an identification of the LLM associated with the prompt style, where the LLM is directly designated as the winning LLM without performing the competition among the contestant LLMs described below. In one embodiment, a prompt style of a given prompt is an intent of the given prompt.

Evaluation criteria determination module 208 is configured to determine one or more evaluation criteria for the prompt. In one embodiment, evaluation criteria determination module 208 sends a request to one of the contestant LLMs to generate one or more evaluation criteria as being suitable for the prompt. In another embodiment, the determination of the one or more evaluation criteria is performed by one or more humans. In one embodiment, evaluation criteria determination module 208 determines the one or more evaluation criteria in response to database check module 206 determining that the prompt style does not already exist in the benchmarking database.

Contest initiation module 210 is configured to distribute, in parallel and simultaneously, the prompt and the one or more evaluation criteria to the contestant LLMs. In one embodiment, contest initiation module 210 distributes the prompt and the one or more evaluation criteria in response to database check module 206 determining that the prompt style does not already exist in the benchmarking database.

Scoring and consensus module 212 is configured to (i) generate a response to the prompt by each of the contestant LLMs, (ii) evaluate the responses by using a scoring and consensus algorithm (e.g., use scores determined for the one or more evaluation criteria), (iii) generate rankings of the responses by the contestant LLMs based on the results of the scoring and consensus algorithm, (iv) determine a top-ranked response by aggregating the rankings from all of the contestant LLMs, and (v) identify a winning LLM from among the contestant LLMs based on the winning LLM having generated the top-ranked response. If the determination of the top-ranked response results in a tie between multiple responses having the same top ranking, then scoring and consensus module 212 repeats the process of evaluating and ranking the responses until exactly one top-ranked response is determined at the end of an iteration of the process. Alternatively, the aforementioned tie is resolved by scoring and consensus module 212 randomly selecting one of the tied top-ranked responses as being the final top-ranked response, where the random selection uses a random number generator (i.e., a hardware random number generator or a pseudorandom number generator).

Database update module 214 is configured to populate the benchmarking database with the processed prompt, the one or more evaluation criteria, the responses, evaluation results, explanations of the responses and the rankings of the responses, and the winning model.

Return winning result module 216 is configured to send the to-ranked response and an identification of the winning LLM to the device or other computer system utilized by the user who provided the prompt. In one embodiment, return winning result module 216 also sends a detailed explanation to the device or other computer system utilized by the user about how and why the LLM was identified as the winning LLM from among the contestant LLMs.

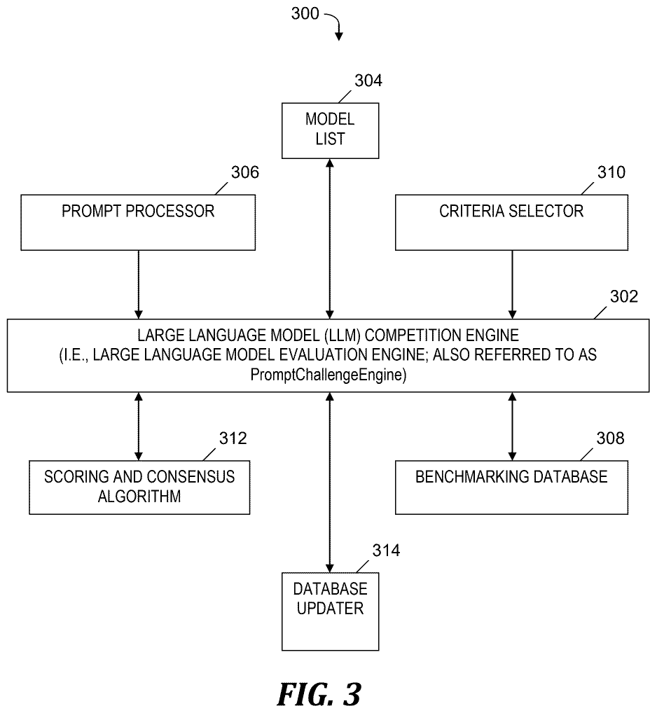

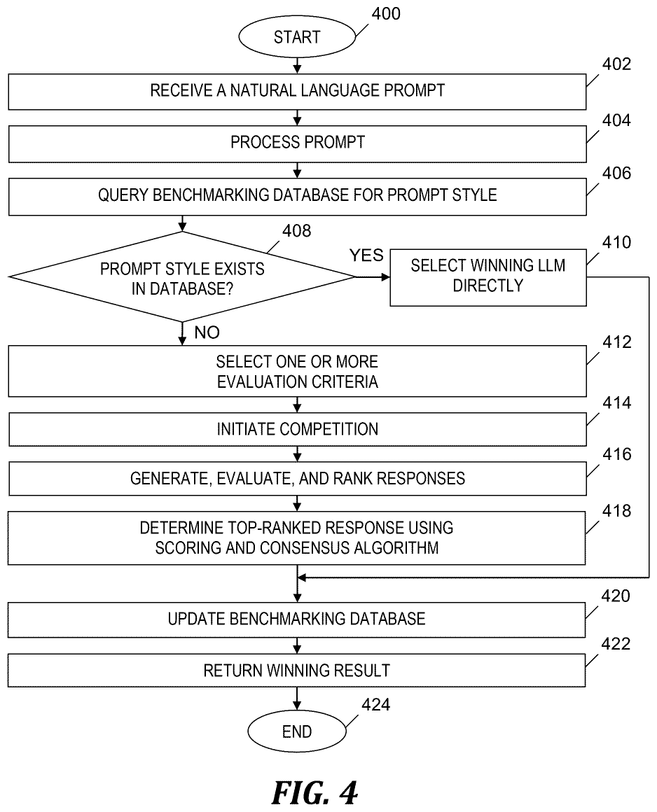

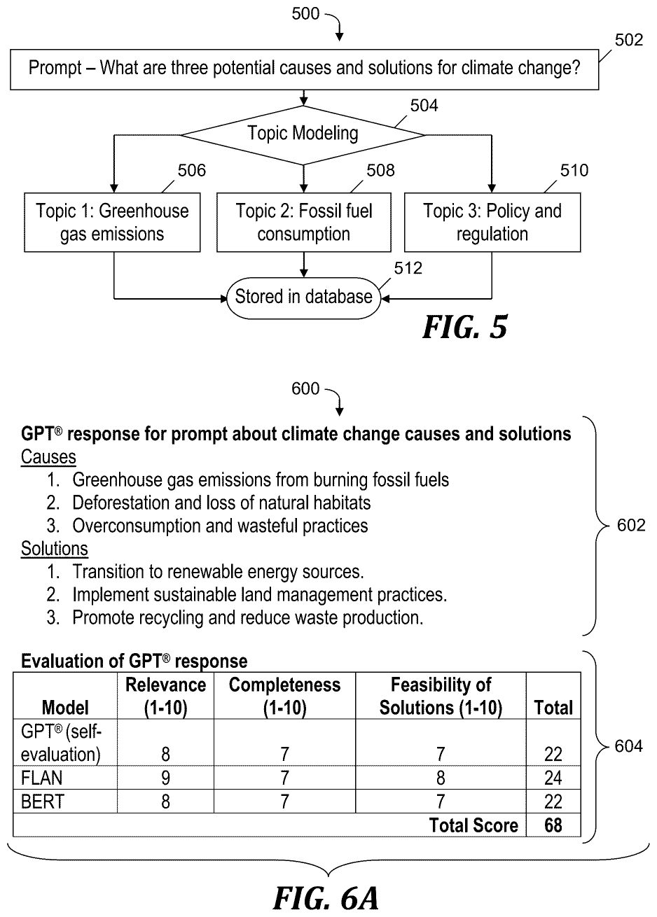

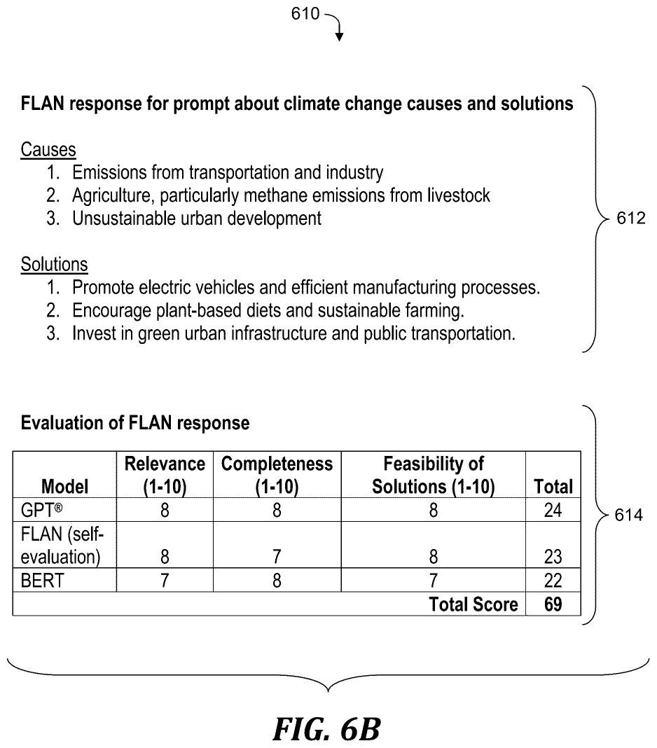

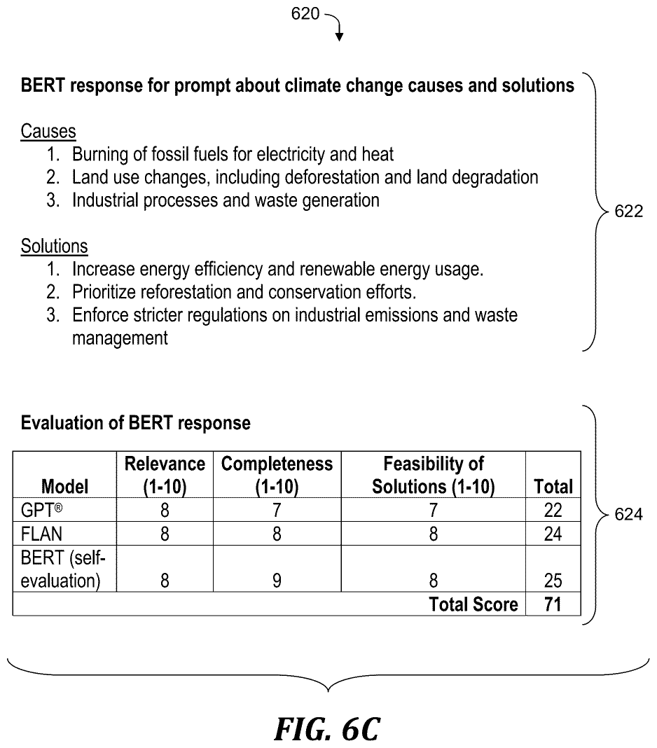

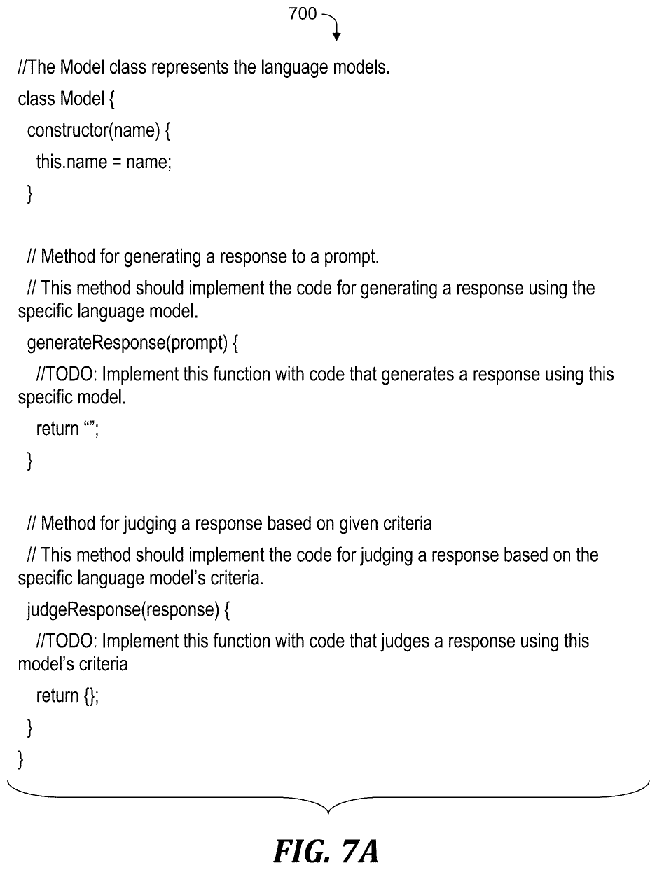

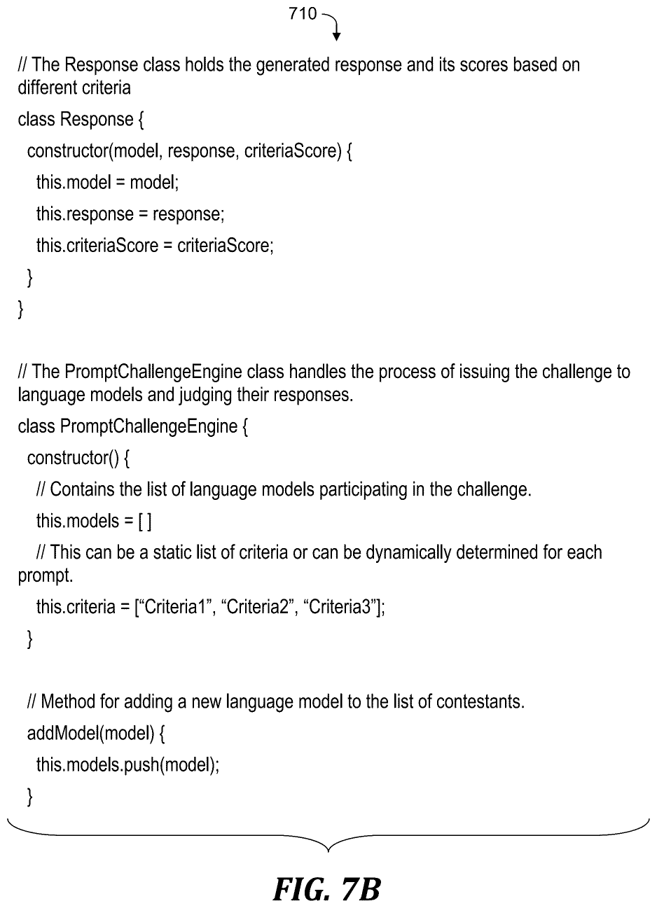

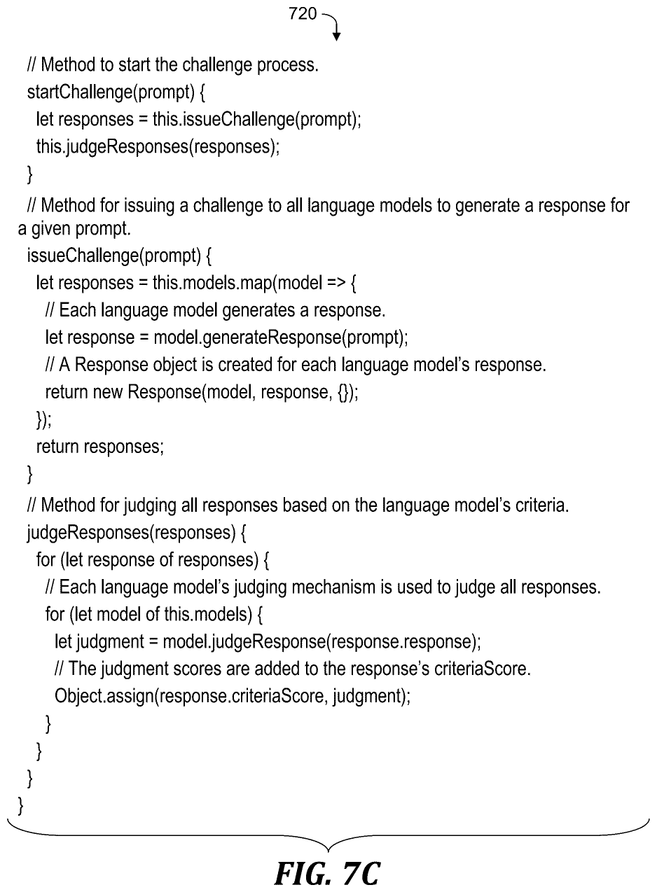

The functionality of the modules included in code 200 is described in more detail in the discussions presented below relative to FIG. 3, FIG. 4, FIG. 5, FIGS. 6A-6C, and FIGS. 7A-7C.

FIG. 3 is a block diagram of a system 300 for selecting an optimal response using a competition among multiple large language models (LLMs), in accordance with embodiments of the present invention. System 300 includes a LLM competition engine 302 (i.e., a large language model evaluation engine; also referred to herein as a PromptChallenge engine or PromptChallengeEngine), a model list 304, a prompt processor 306, a benchmarking database 308, a criteria selector 310, a scoring and consensus algorithm 312, and a database updater 314.

LLM competition engine 302 determines a group of contestant LLMs for the processing of a natural language prompt (not shown) received by system 300, where the group is selected from LLMs included in a model list 304, which maintains an active register of LLMs available as contestant LLMs participating in the selection of optimal responses to prompts. In one embodiment, system 300 dynamically updates model list 304, allowing for the addition or removal of new large language models and versions.

In one embodiment, a classifier (not shown) selects the group of contestant LLMs from model list 304 based on the contestant LLMs having a relevancy measurement that satisfies a threshold requirement or satisfies other relevancy criteria that indicate that the contestant LLMs are relevant to the prompt style or type of the received prompt. In one embodiment, the classifier sends identifications of the selected group of contestant LLMs to LLM competition engine 302.

Prompt processor 306 pre-processes prompts received by system 300 to format the prompts by standardizing and adjusting the prompts to ensure compatibility of the prompts with the contestant LLMs. In one embodiment, prompt processor 306 also receives the prompts.

LLM competition engine 302 consults historical benchmarking data in benchmarking database 308 using topic modeling techniques to determine whether benchmarking database 308 already includes entries that associate the prompt with a winning LLM and responses, where the winning LLM and responses were previously determined by the LLM competition-based optimal response selection process described below.

Benchmarking database 308 provides a historical repository for recording prompts, responses, rankings of the responses, explanations for the responses and rankings, and high-scoring LLMs. Benchmarking database 308 is used for longitudinal tracking and evaluation of LLM performance, enhancing the efficiency of the novel benchmarking process disclosed herein. In one embodiment, entries in benchmarking database 308 include topics extracted from prompts, corresponding responses, explanations of responses and response rankings, results of evaluating responses, and winning LLMs associated with the prompts.

If benchmarking database 308 does not already include entries that associate the prompt with a winning LLM and responses, then criteria selector 310 determines one or more evaluation criteria for evaluating responses to the prompt. Criteria selector 310 determines the one or more evaluation criteria by sending a request to one of the contestant LLMs to generate the one or more evaluation criteria or via a manual (i.e., human) configuration. Furthermore, in response to the determination that benchmarking database 308 does not already include entries that associated the prompt with a winning LLM, LLM competition engine 302 initiates the competition among the contestant LLMs by distributing the prompt, in parallel, to the contestant LLMs, ensuring fair and simultaneous prompt delivery and response generation.

LLM competition engine 302 executes a scoring and consensus operation by using scoring and consensus algorithm 312, where responses generated by the contestant LLMs are evaluated and ranked based on the one or more evaluation criteria. In one embodiment, LLM competition engine 302 uses an aggregation of scores provided by the evaluation to rank the responses and identify the top-ranked response. Alternatively, LLM competition engine 302 uses a consensus algorithm to identify the top-ranked response.

If LLM competition engine 302 cannot determine exactly one winning LLM after the evaluation and ranking (i.e., there is a tie in top rankings indicating that multiple winning LLMs provided multiple top-ranked responses, respectively), then LLM competition engine 302 iterates the process of generating, evaluating, ranking the responses and determining a top-ranked response, until exactly one winning LLM is determined at the end of an iteration of the process. Alternatively, LLM competition engine 302 randomly selects a single winning LLM from among the multiple LLMs that provided the tied top-ranked responses.

After LLM competition engine 302 identifies a winning LLM that provided the top-ranked response, database updater 314 receives information from LLM competition engine 302, where the information includes the topic-modeled prompts, one or more evaluation criteria, explanations of the responses and rankings, evaluation results, and the winning LLM. Database updater 314 updates benchmarking database 308 with the topic-modeled prompts, the one or more evaluation criteria, the explanations, the evaluation results, and the winning LLM. This updating performed by database updater 314 ensures that benchmarking database 308 is consistently up-to-date with the latest benchmarking outcomes, thereby reducing the cost of future benchmarking operations.

The components of system 300 work together to perform LLM selection, prompt processing, response evaluation, and updating of benchmarking database 308, thereby providing a dynamic and effective benchmarking process for the contestant LLMs that identifies a winning LLM from among the contestant LLMs for a given prompt, where the winning LLM provides the top-ranked response.

FIG. 4 is a flowchart of a process of selecting an optimal response for LLM benchmarking, where operations of the flowchart are performed by modules in FIG. 2, which are implemented by the system of FIG. 3, in accordance with embodiments of the present invention. The process of FIG. 4 begins at a start node 400. In step 402, prompt processor 306 receives a natural language prompt from a device or other computer system operated by a user. In one embodiment, prompt receipt module 202 performs step 402.

In step 404, prompt processor 306 processes the prompt received in step 402, which includes pre-processing the prompt to standardize and adjust the prompt to ensure compatibility of the prompt with the contestant LLMs. Prompt processor 306 sends the standardized and adjusted prompt to LLM competition engine 302. In one embodiment, prompt processing module 204 performs step 404.

In step 406, LLM competition engine 302 queries benchmarking database 308 to retrieve the prompt style of the prompt received in step 402 and processed in step 404. Benchmarking database 308 sends the result of the query to LLM competition engine 302.

In step 408, LLM competition engine 302 determines whether the prompt style of the prompt already exists in benchmarking database 308 by using topic modeling techniques. If LLM competition engine 302 determines in step 408 that the prompt style already exists in benchmarking database 308, then the Yes branch of step 408 is followed and step 410 is performed. In step 410, LLM competition engine 302 directly selects the LLM which benchmarking database 308 associates with the prompt style and fetches that LLM from benchmarking database 308, where LLM competition engine 302 designates the selected LLM as the winning LLM for the prompt, thereby bypassing the LLM competition-based process described below. In one embodiment, database check module 206 performs steps 406, 408, and 410.

Returning to step 408, if LLM competition engine 302 determines that the prompt style does not already exist in benchmarking database 308, then the No branch of step 408 is followed and step 412 is performed.

In step 412, criteria selector 310 determines or selects one or more evaluation criteria for evaluating responses to the prompt received in step 402 and processed in step 404. In one embodiment, criteria selector 310 requests a LLM to provide the one or more evaluation criteria. In another embodiment, criteria selector 310 receives the one or more evaluation criteria via a human configuration. In one embodiment, evaluation criteria determination module 208 performs step 412.

In step 414, LLM competition engine 302 initiates the LLM competition-based optimal response selection process by distributing, in parallel, the prompt processed in step 404 and the one or more evaluation criteria selected in step 412 to the contestant LLMs. In one embodiment, contest initiation module 210 performs step 414.

In step 416, LLM competition engine 302 generates, evaluates, and ranks responses to the prompt, where each contestant LLM generates a response to the prompt, and each contestant LLM ranks all the responses based on the one or more evaluation criteria, so a given contestant LLM ranks all the responses including its own response. In one embodiment, LLM competition engine 302 uses scoring and consensus algorithm 312 to evaluate and rank the responses. In one embodiment, each contestant LLM generates confidence levels for the response rankings and provides explanations for the rankings. In one embodiment, scoring and consensus module 212 performs step 416.

In step 418, LLM competition engine 302 determines a top-ranked response by using scoring and consensus algorithm 312 and aggregating rankings from all the contestant LLMs. In step 418, LLM competition engine 302 also determines a winning LLM, which is the contestant LLM that provided the top-ranked response.

In the case of a tie among multiple top-ranked responses, LLM competition engine 302 repeats the process of steps 416 and 418 until exactly one top-ranked response is determined at the end of an iteration of the process. Alternatively, LLM competition engine 302 randomly selects a top-ranked response from among the multiple top-ranked responses, where the random selection uses a random number generator (i.e., hardware random number generator or pseudorandom number generator).

In step 420 which follows step 418, database updater 314 populates benchmarking database 308 with the processed prompt, the one or more evaluation criteria, the responses, the explanations for the responses and rankings, the evaluation results, and the winning LLM. In step 420 which follows step 410 (and the LLM competition-based selection of an optimal response is bypassed), database updater 314 populates benchmarking database 308 with the processed prompt and the winning LLM. In one embodiment, database update module 214 performs step 420.

In step 422, LLM competition engine 302 returns an identification of the winning LLM to the device or other computer system being utilized by the user who provided the prompt. In one embodiment, step 422 includes LLM competition engine 302 sending to the user's device or other computer system a detailed explanation of how and why the winning LLM was selected as the winner. In one embodiment, return winning result module 216 performs step 422.

Following step 422, the process of FIG. 4 ends at an end node 424.

The process of FIG. 4 ensures fairness, accuracy, and efficiency in selecting the optimal response from the multiple responses generated by the multiple contestant LLMs, while maintaining a continuously updated performance log included in benchmarking database 308.

In an alternate embodiment, the selection of the one or more evaluation criteria in step 412 occurs prior the querying of the benchmarking database 308 in step 406.

### PRIVACY PRESERVATION

The system disclosed herein for selecting an optimal response for LLM benchmarking includes a privacy-preserving feature. Literal prompts are not stored. Instead, topic modeling is used to store the topics. An example of the privacy preservation feature is described below.

LLM competition engine 302 uses topic modeling to extract various topics related to the prompt “What are the three potential causes and solutions for climate change?” LLM competition engine 302 derives potential topics as listed below:
1. Greenhouse gas emissions
2. Deforestation and land-use changes
3. Fossil fuel consumption
4. Renewable energy and sustainable solutions
5. Policy and regulation
6. Carbon sequestration
7. Industrial processes and pollution
8. Public awareness and education
9. Biodiversity loss
10. Energy efficiency

To store information in the benchmarking database 308 without storing the actual prompt itself, LLM competition engine 302 creates a structure where each entry includes the extracted topics and relevant information associated with the prompt. LLM competition engine 302 can store the information as shown in the example presented below:

### Entry 1

Topics: Greenhouse gas emissions, Fossil fuel consumption, Policy and regulation
Response: “The three potential causes of climate change include greenhouse gas emissions from human activities, increased use of fossil fuels, and the need for effective policy and regulation to tackle the issue.”

### Entry 2

Topics: Deforestation and land-use changes, Renewable energy and sustainable solutions
Response: “Deforestation and land-use changes contribute to climate change. Solutions include promoting renewable energy sources and implementing sustainable land management practices.”

By storing the extracted topics along with the corresponding responses, LLM competition engine 302 categorizes and retrieves information based on these topics without directly storing the actual prompt. This usage of topic modeling allows for efficient retrieval and analysis of responses while maintaining privacy and reducing redundancy in the benchmarking database 308. The process of using topic modeling for the aforementioned prompt and Entry 1 is further illustrated in the example in FIG. 5

FIG. 5 is an example 500 of topic modeling used to implement privacy preservation in the process of FIG. 4, in accordance with embodiments of the present invention. Example 500 includes a prompt 502, which asks “What are three potential causes and solutions for climate change?” LLM competition engine 302 uses topic modeling 504 to extract topic 506 (i.e., Topic 1: Greenhouse gas emissions), topic 508 (i.e., Topic 2: Fossil fuel consumption), and topic 510 (i.e., Topic 3: Policy and regulation) related to the prompt 502 (i.e., prompt 502 is transformed into topic models for privacy preservation). LLM competition engine 302 performs a storing operation so that the extracted topics (i.e., topics 506, 508, and 510) and the corresponding response are stored in database 512.

### EXAMPLES

In the system disclosed herein for selecting an optimal response for LLM benchmarking, each contestant LLM generates a response to a given prompt, with subsequent evaluation of the responses carried out by the contestant LLMs acting as judging LLMs. For example, consider the user prompt: “Help me write a two sum function using the PYTHON® language.” PYTHON is a registered trademark of Python Software Foundation located in Beaverton, Oregon. A judging LLM suggests the following criteria: “Accuracy, Efficiency, Readability, Maintainability, Robustness.”

Subsequently, each judging LLM is instructed to generates a response to the user prompt. Together with their generated response, each judging LLM also generates a JAVASCRIPT® Object Notation (JSON) document. JAVASCRIPT is a registered trademark of Oracle America, Inc. located in Redwood Shores, California. For each of the established evaluation criteria, the JSON document provides a rating on a scale of 1 to 10 regarding how adequately the response meets a given evaluation criterion, accompanied by an explanation.

LLM competition engine 302 uses an interactive and self-evaluating process to generate and assess responses from the contestant LLMs. The selected evaluation criteria used to evaluate the responses ensure that the selected responses are not only accurate and efficient, but also maintainable and robust, lending them greater utility and effectiveness in application. The process disclosed herein of optimal response selection for selecting a winning LLM is dynamic, scalable, and adaptable to a wide array of prompts, making the process a powerful tool in the field of NLP.

FIGS. 6A-6C depict an example of selecting an optimal response and a winning LLM by using the process of FIG. 4, in accordance with embodiments of the present invention. The example in FIGS. 6A-6C present a simulation table in portions 600, 610, and 620 for the prompt: “What are the three potential causes and solutions for climate change?” for the LLMs GPT®, FLAN, and BERT. GPT is a registered trademark of OpenAI OpCo LLC located in San Francisco, California. The table includes the prompt, the topic model relevant columns, the responses generated by each LLM, and the corresponding scores for each of the evaluation criteria (i.e., Relevance, Completeness, and Feasibility of Solutions, which are selected as being relevant to the prompt).

Table portion 600 in FIG. 6A includes a response 602 from the GPT® model and an evaluation 604 of the response 602. Evaluation 604 includes integer scores in the range of 1 to 10, inclusive, where the self-evaluated total aggregated scores for the GPT® model is 22 (i.e., 8 for Relevance+7 for Completeness+7 for Feasibility of Solutions=22), the total aggregated scores for the FLAN model is 24 and the total aggregated scores for the BERT model is 22. Evaluation 604 indicates that the Total Score for response 602 is 68 (i.e., 22+24+22=68).

Table portion 610 in FIG. 6B includes a response 612 from the FLAN model and an evaluation 614 of the response 612. Evaluation 614 includes integer scores in the range of 1 to 10, inclusive. The total aggregated scores in evaluation 614 include: 24 for the GPT® model, 23 for the FLAN model (as a self-evaluated score), and 22 for the BERT model. Evaluation 614 indicates that the Total Score for response 612 is 69 (i.e., 24+23+22=69).

Table portion 620 in FIG. 6C includes a response 622 from the BERT model and an evaluation 624 of the response 622. Evaluation 624 includes integer scores in the range of 1 to 10, inclusive. The total aggregated scores in evaluation 624 include: 22 for the GPT® model, 24 for the FLAN model, and 25 for the BERT model (as a self-evaluated score). Evaluation 624 indicates that the Total Score for response 622 is 71 (i.e., 22+24+25=71).

Because the Total Score (i.e., 71) for the response 622 from the BERT model is the greatest (i.e., 71 is greater than 69 for the response 612 from the FLAN model and greater than 68 for the response 602 from the GPT® model), the example in FIGS. 6A-6C indicates that response 622 is the top-ranked response and BERT is the winning model (i.e., performed best for the prompt).

FIGS. 7A-7C depict an example of code illustrating a conceptual framework and a core logic of a large language model evaluation engine included in the system of FIG. 3, in accordance with embodiments of the present invention. The code is in three portions: portion 700 in FIG. 7A, portion 710 in FIG. 7B, and portion 720 in FIG. 7C.

Portion 700 specifies the class Model that represents the large language models, and includes a method for generating a response to a prompt and another method for judging a response based on given evaluation criteria.

Portion 710 specifies the class Response that holds the generated response and scores for the response based on the evaluation criteria, and further specifies the class PromptChallengeEngine that handles the process of initiating the competition among the contestant large language models and judging the responses generated by the contestant large language models. Portion 710 also includes a method for adding a new model to the list of contestant large language models.

Portion 720 includes a method to start the competition among the contestant large language models, a method for issuing a challenge to all the contestant large language models to generate a response for a given prompt, and a method for judging all the responses based on the language model's evaluation criteria.

Portions 700, 710, and 720 of code can serve to orchestrate a competition among different large language models for generating and judging responses to a given prompt to provide a privacy-preserving, scalable, and accurate solution to select the best language model for a given prompt (i.e., select the language model that generates a top-ranked response for the given prompt).

The descriptions of the various embodiments of the present invention have been presented herein for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
receiving a prompt from a user and standardizing and adjusting the prompt by pre-processing, tokenizing, and cleaning the prompt, so that the standardized and adjusted prompt is compatible with contestant large language models (LLMs);
determining one or more evaluation criteria for evaluating responses to the prompt;
distributing, in parallel and simultaneously, the prompt and the one or more evaluation criteria to the contestant LLMs;
generating and evaluating the responses to the prompt and based on the one or more evaluation criteria, generating rankings of the responses, wherein the responses and the rankings are generated by the contestant LLMs, respectively;
determining a top-ranked response included in the responses by aggregating the rankings, and identifying a winning LLM among the contestant LLMs based on the winning LLM having generated the top-ranked response; and
sending the top-ranked response and an identification of the winning LLM to the user.

2. The method of claim 1, further comprising:
determining a style of the prompt;
determining that the style of the prompt does not already exist in a benchmarking database by querying the benchmarking database for the style, wherein the distributing the prompt is performed in response to the determining that the style does not already exist in the benchmarking database;
updating a benchmarking database with the standardized and adjusted prompt, the one or more evaluation criteria, the responses, explanations of the rankings, the top-ranked response, and the winning LLM; and
updating the benchmarking database further over time with other standardized and adjusted prompts, other evaluation criteria, other responses, other explanations of other rankings, other top-ranked responses, and other winning LLMs, which results in a decreased need over time to perform an evaluation of at least some subsequent prompts by evaluation criteria and a determination of subsequent top-ranked responses for the at least some subsequent prompts, which results in a benchmarking process that is more cost-effective than a traditional benchmarking process that does not include the updating the benchmarking database over time.

3. The method of claim 2, further comprising:
receiving another prompt from the user or another user and standardizing and adjusting the other prompt, so that the standardized and adjusted other prompt is compatible with the contestant LLMs;
determining a style of the other prompt;
determining that the style of the other prompt already exists in the benchmarking database by querying the benchmarking database for the style of the other prompt;
in response to the determining that the style of the other prompt already exists in the benchmarking database, selecting an LLM from the contestant LLMs based on the LLM being associated with the style of the other prompt in the benchmarking database; and
sending an identification of the selected LLM to the user or the other user, without distributing the other prompt to the contestant LLMs, without generating and evaluating other responses to the other prompt by the contestant LLMs, without generating other rankings of the other responses by the contestant LLMs, and without determining a top-ranked response included in the other responses by aggregating the other rankings.

4. The method of claim 1, further comprising:
providing ongoing benchmarking of the contestant LLMs by repeatedly using the determining the one or more evaluation criteria, the distributing the prompt and the one or more evaluation criteria, the generating and the evaluating the responses, the generating the rankings of the responses; and
based on the ongoing benchmarking, providing an evaluation and a ranking of subsequent responses while ensuring an accuracy of the evaluation and the ranking of the subsequent responses, even though one or more contestant LLMs have improved after an evaluation and a ranking of previous responses.

5. The method of claim 1, further comprising:
requesting a contestant LLM included in the contestant LLMs to generate the one or more evaluation criteria; and
generating the one or more evaluation criteria by the contestant LLM,
wherein the responses and the rankings being generated by the contestant LLMs, and the one or more evaluation criteria being generated by the contestant LLM provides a benchmarking process for LLMs that eliminates human bias and enhances accuracy and fairness.

6. The method of claim 1, further comprising:
determining a context of the prompt, wherein the generating and the evaluating the responses and the determining the top-ranked response are based on the context of the prompt, which ensures that the winning LLM is contextually relevant to the prompt.

7. The method of claim 1, further comprising:
generating scoring criteria tailored to specifics of the prompt, wherein the evaluating the responses and the generating the rankings of the responses includes using the scoring criteria, which provides an accuracy in a comprehensive evaluation of performances of the contestant LLMs.

8. The method of claim 1, further comprising:
generating respective confidence levels and respective explanations for the rankings, wherein a confidence level included in the confidence levels and an explanation included in the explanations are associated with a ranking of the top-ranked response, and wherein the sending the top-ranked response and the identification of the winning LLM to the user includes sending to the user the confidence level and the explanation.

9. The method of claim 1, further comprising:
determining that an initial performance of the generating and the evaluating the responses to the prompt, the generating the rankings of the responses, and determining the top-ranked response results in a tie in top rankings of a first response and a second response included in the responses; and
performing one or more subsequent iterations of the generating and the evaluating the responses, the generating the rankings of the responses, and the determining the top-ranked response until the top-ranked response is determined without a ranking of another response being tied with a ranking of the top-ranked response.

10. The method of claim 1, further comprising:
verifying that the standardized and adjusted prompt is compatible with the contestant LLMs, wherein the determining the one or more evaluation criteria is performed in response to the verifying.

11. The method of claim 1, further comprising:
maintaining an active register of LLMs which are available to be the contestant LLMs in an evaluation of responses to prompts, wherein the register includes model annotations that are continuously updated with classification information that specifies types of prompts associated with the LLMs in the active register;
determining a type of the prompt; and
selecting the contestant LLMs from the active register of LLMs based on the active register specifying an association between the type of the prompt and each of the contestant LLMs in the active register.

12. A computer system comprising:
a processor set;
one or more computer-readable storage media; and
program instructions stored on the one or more computer-readable storage media to cause the processor set to perform operations comprising:
receiving a prompt from a user and standardizing and adjusting the prompt by pre-processing, tokenizing, and cleaning the prompt, so that the standardized and adjusted prompt is compatible with contestant large language models (LLMs);
determining one or more evaluation criteria for evaluating responses to the prompt;
distributing, in parallel and simultaneously, the prompt and the one or more evaluation criteria to the contestant LLMs;
generating and evaluating the responses to the prompt and based on the one or more evaluation criteria, generating rankings of the responses, wherein the responses and the rankings are generated by the contestant LLMs, respectively;
determining a top-ranked response included in the responses by aggregating the rankings, and identifying a winning LLM among the contestant LLMs based on the winning LLM having generated the top-ranked response; and
sending the top-ranked response and an identification of the winning LLM to the user.

13. The computer system of claim 12, wherein the operations further comprise:
determining a style of the prompt;
determining that the style of the prompt does not already exist in a benchmarking database by querying the benchmarking database for the style, wherein the distributing the prompt is performed in response to the determining that the style does not already exist in the benchmarking database;
updating a benchmarking database with the standardized and adjusted prompt, the one or more evaluation criteria, the responses, explanations of the rankings, the top-ranked response, and the winning LLM; and
updating the benchmarking database further over time with other standardized and adjusted prompts, other evaluation criteria, other responses, other explanations of other rankings, other top-ranked responses, and other winning LLMs, which results in a decreased need over time to perform an evaluation of at least some subsequent prompts by evaluation criteria and a determination of subsequent top-ranked responses for the at least some subsequent prompts, which results in a benchmarking process that is more cost-effective than a traditional benchmarking process that does not include the updating the benchmarking database over time.

14. The computer system of claim 13, wherein the operations further comprise:
receiving another prompt from the user or another user and standardizing and adjusting the other prompt, so that the standardized and adjusted other prompt is compatible with the contestant LLMs;
determining a style of the other prompt;
determining that the style of the other prompt already exists in the benchmarking database by querying the benchmarking database for the style of the other prompt;
in response to the determining that the style of the other prompt already exists in the benchmarking database, selecting an LLM from the contestant LLMs based on the LLM being associated with the style of the other prompt in the benchmarking database; and
sending an identification of the selected LLM to the user or the other user, without distributing the other prompt to the contestant LLMs, without generating and evaluating other responses to the other prompt by the contestant LLMs, without generating other rankings of the other responses by the contestant LLMs, and without determining a top-ranked response included in the other responses by aggregating the other rankings.

15. The computer system of claim 12, wherein the operations further comprise:
providing ongoing benchmarking of the contestant LLMs by repeatedly using the determining the one or more evaluation criteria, the distributing the prompt and the one or more evaluation criteria, the generating and the evaluating the responses, the generating the rankings of the responses; and
based on the ongoing benchmarking, providing an evaluation and a ranking of subsequent responses while ensuring an accuracy of the evaluation and the ranking of the subsequent responses, even though one or more contestant LLMs have improved after an evaluation and a ranking of previous responses.

16. The computer system of claim 12, wherein the operations further comprise:
requesting a contestant LLM included in the contestant LLMs to generate the one or more evaluation criteria; and
generating the one or more evaluation criteria by the contestant LLM,
wherein the responses and the rankings being generated by the contestant LLMs, and the one or more evaluation criteria being generated by the contestant LLM provides a benchmarking process for LLMs that eliminates human bias and enhances accuracy and fairness.

17. A computer program product comprising:
one or more computer-readable storage media; and program instructions stored on the one or more computer-readable storage media to perform operations comprising:
receiving a prompt from a user and standardizing and adjusting the prompt by pre-processing, tokenizing, and cleaning the prompt, so that the standardized and adjusted prompt is compatible with contestant large language models (LLMs);
determining one or more evaluation criteria for evaluating responses to the prompt;
distributing, in parallel and simultaneously, the prompt and the one or more evaluation criteria to the contestant LLMs;
generating and evaluating the responses to the prompt and based on the one or more evaluation criteria, generating rankings of the responses, wherein the responses and the rankings are generated by the contestant LLMs, respectively;
determining a top-ranked response included in the responses by aggregating the rankings, and identifying a winning LLM among the contestant LLMs based on the winning LLM having generated the top-ranked response; and
sending the top-ranked response and an identification of the winning LLM to the user.

18. The computer program product of claim 17, wherein the operations further comprise:
determining a style of the prompt;
determining that the style of the prompt does not already exist in a benchmarking database by querying the benchmarking database for the style, wherein the distributing the prompt is performed in response to the determining that the style does not already exist in the benchmarking database;
updating a benchmarking database with the standardized and adjusted prompt, the one or more evaluation criteria, the responses, explanations of the rankings, the top-ranked response, and the winning LLM; and
updating the benchmarking database further over time with other standardized and adjusted prompts, other evaluation criteria, other responses, other explanations of other rankings, other top-ranked responses, and other winning LLMs, which results in a decreased need over time to perform an evaluation of at least some subsequent prompts by evaluation criteria and a determination of subsequent top-ranked responses for the at least some subsequent prompts, which results in a benchmarking process that is more cost-effective than a traditional benchmarking process that does not include the updating the benchmarking database over time.

19. The computer program product of claim 18, wherein the operations further comprise:
receiving another prompt from the user or another user and standardizing and adjusting the other prompt, so that the standardized and adjusted other prompt is compatible with the contestant LLMs;
determining a style of the other prompt;
determining that the style of the other prompt already exists in the benchmarking database by querying the benchmarking database for the style of the other prompt;
in response to the determining that the style of the other prompt already exists in the benchmarking database, selecting an LLM from the contestant LLMs based on the LLM being associated with the style of the other prompt in the benchmarking database; and
sending an identification of the selected LLM to the user or the other user, without distributing the other prompt to the contestant LLMs, without generating and evaluating other responses to the other prompt by the contestant LLMs, without generating other rankings of the other responses by the contestant LLMs, and without determining a top-ranked response included in the other responses by aggregating the other rankings.

20. The computer program product of claim 17, wherein the operations further comprise:
providing ongoing benchmarking of the contestant LLMs by repeatedly using the determining the one or more evaluation criteria, the distributing the prompt and the one or more evaluation criteria, the generating and the evaluating the responses, the generating the rankings of the responses; and
based on the ongoing benchmarking, providing an evaluation and a ranking of subsequent responses while ensuring an accuracy of the evaluation and the ranking of the subsequent responses, even though one or more contestant LLMs have improved after an evaluation and a ranking of previous responses.
